(19) United States
(12) Patent Application Publication
(10) Pub. No.: US 2022/0183109 A1
(43) Pub. Date: Jun. 9, 2022

(54) RELAY DEVICE FOR VEHICLE COMMUNICATION, RELAY METHOD FOR VEHICLE COMMUNICATION, AND NON-TRANSITORY STORAGE MEDIUM ON WHICH A PROGRAM IS STORED

(71) Applicant: TOYOTA JIDOSHA KABUSHIKI KAISHA, Toyota-shi (JP)

(72) Inventor: Kunihiro MIYAUCHI, Toyota-shi (JP)

(73) Assignee: TOYOTA JIDOSHA KABUSHIKI KAISHA, Toyota-shi (JP)

(21) Appl. No.: 17/518,500

(22) Filed: Nov. 3, 2021

(30) Foreign Application Priority Data
Dec. 9, 2020 (JP) 2020-204501

(51) Int. Cl. H04W 88/04; H04L 12/66; H04W 4/40; H04L 29/08

(52) U.S. Cl. CPC H04W 88/04; H04L 67/12; H04W 4/40; H04L 12/66

(57) ABSTRACT

A relay device for vehicle communication includes: a receiving section that receives data for vehicle communication; a relay processing section that transfers the data received at the receiving section to a bus; a storing processing section that temporarily stores the data received at the receiving section; and a data packing section that collects a plurality of the data stored at the storing processing section, and converts the plurality of data into single data for verification.

### CROSS-REFERENCE TO RELATED APPLICATION

This application is based on and claims priority under 35 USC 119 from Japanese Patent Application No. 2020-204501 filed on Dec. 9, 2020, the disclosure of which is incorporated by reference herein.

### BACKGROUND

### Technical Field

The present disclosure relates to a relay device for vehicle communication, a relay method for vehicle communication, and non-transitory storage medium on which a program is stored.

### Related Art

A communication relay device that has a computing processing section that verifies data that is the object of relaying is disclosed in Japanese Patent Application Laid-Open (JP-A) No. 2011-61415. In the communication relay device of JP-A No. 2011-61415, if the load on the computing processing section is less than or equal to a threshold value, data is relayed after verification of the data is carried out. On other hand, in a case in which the load on the computing processing section exceeds the threshold value, data is relayed while transmitting the data to a relay data storing section, and, when the load is low, verification of the data that is stored in the relay data storing section is carried out.

However, in an on-vehicle network, data of small sizes are transmitted frequently. Therefore, by transmitting data to the relay data storing section that is for verification, the processing load increases, and there is the concern that the relaying of the data will be delayed.

### SUMMARY

The present disclosure provides a relay device for vehicle communication, a relay method for vehicle communication, and non-transitory storage medium on which a program is stored, which may suppress an increase in processing load.

A first aspect of the present disclosure is a relay device for vehicle communication including: a receiving section that receives data for vehicle communication; a relay processing section that transfers the data received at the receiving section to a bus; a storing processing section that temporarily stores the data received at the receiving section; and a data packing section that collects a plurality of the data stored at the storing processing section, and converts the plurality of data into single data for verification.

In the relay device for vehicle communication of the first aspect, data for vehicle communication is received by the receiving section. The received data is transferred to another bus by the relay processing section. In this way, by successively transferring the received data, delays in relaying may be suppressed more so than in a case in which data is transferred after being verified.

Further, the received data is temporarily stored by the storing processing section. Moreover, the data packing section collects the plural stored data, and converts the plural data into single data for verification. Due thereto, the header may be made smaller by an amount corresponding to the collecting of the plural data, and the processing load may be reduced.

A second aspect of the present disclosure, in the first aspect, may further include: a data for verification transmitting section that transmits the data for verification to a data storing section that is for verification.

In the relay device for vehicle communication of the second aspect, the number of times of transmitting the data for verification may be reduced as compared with a case in which the data are transmitted individually.

In a third aspect of the present disclosure, in the second aspect, the data for verification transmitting section may transmit the data for verification by a communication protocol of a wider band than a communication protocol used at the receiving section.

In the relay device for vehicle communication of the third aspect, a large amount of data may be transmitted at one time by transmitting the data for verification by using a communication protocol of a wide band.

A fourth aspect of the present disclosure, in the second aspect or the third aspect, the data packing section may pack the data that is stored in the storing processing section, in a case in which a total data size of the data stored by the storing processing section is greater than or equal to a predetermined threshold value, or in a case in which a predetermined time period has elapsed from transmitting of the data for verification by the data for verification transmitting section.

In the relay device for vehicle communication of the fourth aspect, in a case in which the total data size of the data that is stored by the storing processing section is greater than or equal to a predetermined threshold value, the data packing section packs the data. Due thereto, overflowing of the stored data may be avoided. Further, in a case in which a predetermined time period has elapsed from the transmitting to the data storing section, the data packing section packs the data, and the data for verification may thereby be packed and transmitted periodically.

A fifth aspect of the present disclosure, in any one aspect of the second aspect through the fourth aspect, may further include: a processing load acquiring section that acquires a processing load after relay processing by the relay processing section, wherein, in a case in which the processing load acquired by the processing load acquiring section is greater than or equal to a predetermined threshold value, the data for verification transmitting section temporarily stops transmission to the data storing section.

In the relay device for vehicle communication of the fifth aspect, by temporarily stopping transmission to the data storing section in a case in which the processing load is greater than or equal to the predetermined threshold value, the transfer of data by the relay processing section being delayed may be suppressed.

A sixth aspect of the present disclosure, in any one aspect of the first aspect through the fifth aspect, may further include: a receiving bus information adding section that adds receiving bus information to the data received at the receiving section.

In the relay device for vehicle communication of the sixth aspect, due to receiving bus information being added by the receiving bus information adding section, the receiving bus information may be referenced at the time of verification and may be used in the judging of improper data.

A seventh aspect of the present disclosure, in any one aspect of the first aspect through the sixth aspect, may further include: a received time adding section that adds received time information, which is based on a time of receiving, to the data received at the receiving section.

In the relay device for vehicle communication of the seventh aspect, due to received time information being added by the received time information adding section, the received time information may be referenced at the time of verification and may be used in the judging of improper data.

In an eighth aspect of the present disclosure, in the seventh aspect, the received time information may be a counter timer value that is reset at a time when the data is transmitted.

In the relay device for vehicle communication of the eighth aspect, by adding the counter timer value as the received time information, a function that acquires the time from the exterior or the like is not needed, as compared with a case of using an absolute time such as Greenwich Mean Time (GMT) or the like.

In a ninth aspect of the present disclosure, in any one aspect of the second aspect through the sixth aspect, the data for verification transmitting section may transmit the data for verification at a predetermined period.

In the relay device for vehicle communication of the ninth aspect, by transmitting the data for verification at a predetermined period, there is no need to add the received time information, and the data size may be made smaller. Further, if the data for verification is transmitted periodically, the time of receiving may be discriminated by the difference in the period, and improper data may be judged on the basis of this time of receiving.

A tenth aspect of the present disclosure is a relay method for vehicle communication, the method including: receiving data for vehicle communication; transferring the received data to a bus, and temporarily storing the received data; and collecting a plurality of the stored data, and converting the plurality of data into single data for verification.

An eleventh aspect of the present disclosure is a non-transitory storage medium that stores a program that is executable by a computer to perform processing, the processing including: receiving data for vehicle communication; transferring the received data to a bus, and temporarily storing the received data; and collecting a plurality of the stored data, and converting the plurality of data into single data for verification.

As described above, in accordance with the relay device for vehicle communication, the relay method for vehicle communication, and the program relating to the present disclosure, an increase in processing load may be suppressed.

### BRIEF DESCRIPTION OF THE DRAWINGS

An exemplary embodiment of the present disclosure will be described in detail based on the following figures, wherein:

FIG. 1 is a block drawing illustrating hardware structures of a relay device relating to the embodiment;

FIG. 2 is a block drawing illustrating functional structures of a CPU core in the embodiment;

FIG. 3 is a block drawing illustrating functional structures of a CPU core in the embodiment;

FIG. 4 is a flowchart illustrating an example of the flow of relay processing of the CPU core in the embodiment;

FIG. 5 is a flowchart illustrating an example of the flow of verification processing of the CPU core in the embodiment;

FIG. 6 is a drawing illustrating an example of relay information;

FIG. 7 is a drawing illustrating an example of the frame structure of data for verification in the embodiment;

FIG. 8A is a drawing illustrating a first modified example of the frame structure of the data for verification; and

FIG. 8B is a drawing illustrating a second modified example of the frame structure of the data for verification.

### DETAILED DESCRIPTION

A relay device 10 relating to an embodiment is described with reference to the drawings.

### Hardware Structures of Relay Device 10

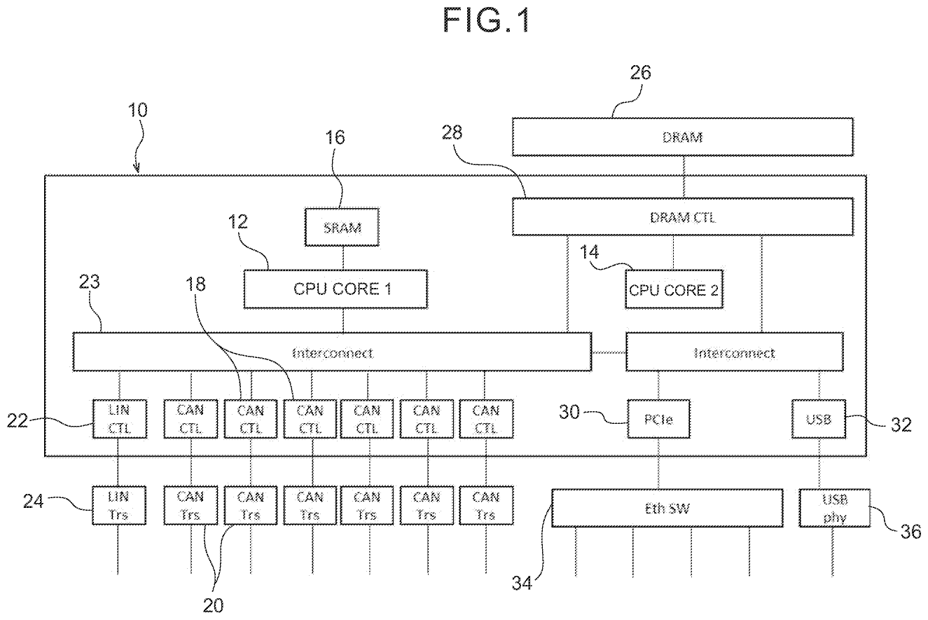

As illustrated in FIG. 1, the relay device 10 for vehicle communication of the present embodiment (hereinafter called Delay device 10 for convenience) is structured to include a CPU core 12, a CPU core 14 and an SRAM 16. The relay device 10 is installed in a vehicle, and is, for example, an ECU (Electronic Control Unit) with a gateway function.

The relay device 10 has plural communication interfaces. Concretely, the relay device 10 has plural CAN (Controller Area Network) controllers 18 for relaying CAN data, which is received from a CAN channel, to another CAN channel. The plural CAN controllers 18 are electrically connected to the CPU core 12 via a bus 23, and receive CAN data from CAN transceivers 20. Further, a LIN (Local Interconnect Network) controller 22 for receiving LIN data is connected to the bus 23. The LIN controller 22 receives LIN data from a LIN transceiver 24.

The CPU core 12 is connected to the SRAM (Static Random Access Memory) 16, and temporarily stores the received CAN data in the SRAM 16. Further, relay information expressing a routing map is stored in the SRAM 16.

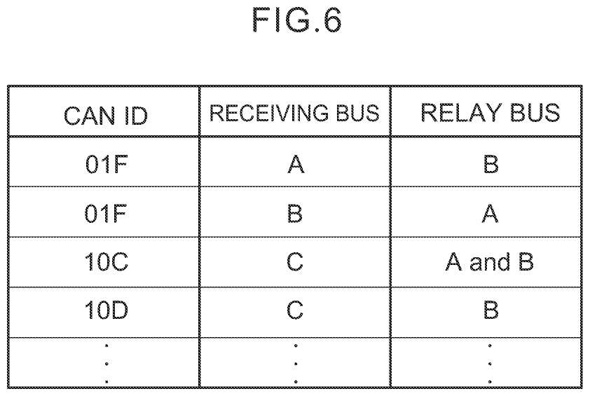

An example of the relay information is illustrated in FIG. 6. As illustrated in FIG. 6, the relay information is information that is in a table format for example. A CAN ID, receiving bus information that expresses the bus that received the CAN data, and relay bus information that expresses the bus that is the destination of relaying, are set in correspondence with one another.

The CPU core 12 refers to the CAN ID from the received CAN data, and confirms whether the receiving bus that actually received the CAN data, and the receiving bus information that is stored in the relay information, match. If the receiving bus that received the CAN data and the receiving bus information match, the CPU core 12 transfers the CAN data on the basis of the corresponding relay bus information. If the receiving bus that received the CAN data and the receiving bus information do not match, the CPU core 12 does not execute relay processing.

On the other hand, the CPU core 14 is electrically connected to the CPU core 12. Further, the CPU core 14 is connected to a DRAM controller 28 for accessing a DRAM (Dynamic Random Access Memory) 26.

The relay device 10 has a PCIe (Peripheral Component Interconnect express) 30 and a USB (Universal Serial Bus) 32. The relay device 10 receives and transmits data in Ethernet frame format via the PCIe 30 and an ethernet switch 34. Moreover, the relay device 10 receives and transmits data of various formats via the USB 32 and a USBphy 36.

### Functional Structures of Relay Device 10

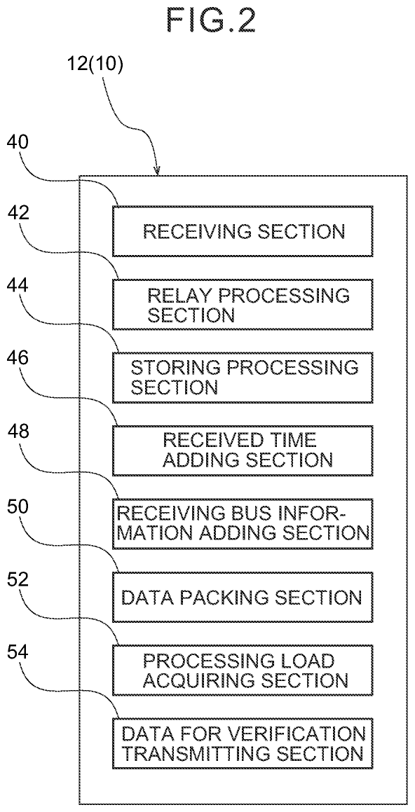

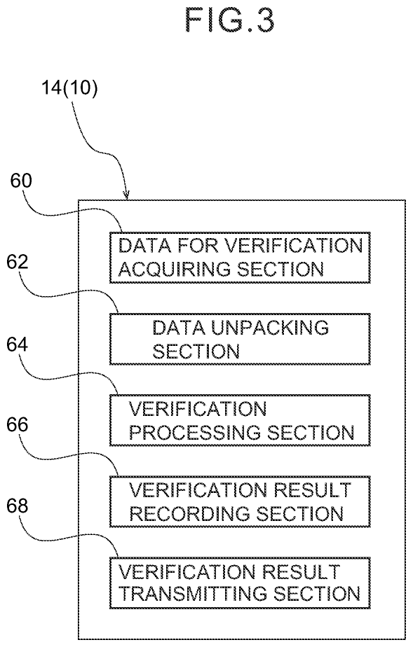

The relay device 10 realizes various functions by using the above-described hardware resources. The functional structures that are realized by the relay device 10 are described with reference to FIG. 2 and FIG. 3. The functional structures that are realized by the CPU core 12 are illustrated in FIG. 2, and the functional structures that are realized by the CPU core 14 are illustrated in FIG. 3.

### Functional Structures of CPU Core 12

As illustrated in FIG. 2, the CPU core 12 of the relay device 10 is structured to include, as the functional structures thereof, a receiving section 40, a relay processing section 42, a storing processing section 44, a received time adding section 46, a receiving bus information adding section 48, a data packing section 50, a processing load acquiring section 52, and a data for verification transmitting section 54. These respective functional structures are realized by the CPU core 12 reading-out and executing a program.

The receiving section 40 receives data for vehicle communication. The receiving section 40 of the present embodiment receives CAN data from the exterior of the relay device 10. As an example, the receiving section 40 receives CAN data via the CAN controller 18 from control devices of a CAN communication system such as an engine ECU, a brake ECU, a steering ECU and the like.

The relay processing section 42 transfers the CAN data that was received at the receiving section 40 to another CAN channel. Concretely, the relay processing section 42 refers to the relay information that is illustrated in FIG. 6, and transfers the CAN data to the relay bus that corresponds to the CAN ID of the received CAN data and the receiving bus information.

As illustrated in FIG. 2, the storing processing section 44 temporarily stores the CAN data, which was received at the receiving section 40, in the SRAM 16. Namely, the CAN data that was received at the receiving section 40 is transferred by the relay processing section 42. Further, the CAN data that was received at the receiving section 40 is temporarily stored in the SRAM 16 by the storing processing section 44.

The received time adding section 46 adds received time information that is based on the time of receiving to the CAN data that was received at the receiving section 40. Various information can be used as the received time information. In the present embodiment, as an example, the received time adding section 46 adds a counter timer value as the received time information to the CAN data. The counter timer value is time information in which counting starts at a predetermined time, and the count is reset by a reset instruction. Other than this, Greenwich Mean Time (GMT) or Coordinated Universal Time (UTC) or the like may be acquired, and such an absolute time may be used as the time information.

The receiving bus information adding section 48 adds receiving bus information to the CAN data that was received at the receiving section 40. The receiving bus information that is added by the receiving bus information adding section 48 is referred to at the time of verification, and is used in detecting improper data.

The data packing section 50 collects the plural CAN data that are stored in the storing processing section 44, and packs (converts) them into a single data for verification. In the present embodiment, as an example, the data packing section 50 packs the CAN data that was used at the receiving section 40, and converts the packed data into Ethernet frame format.

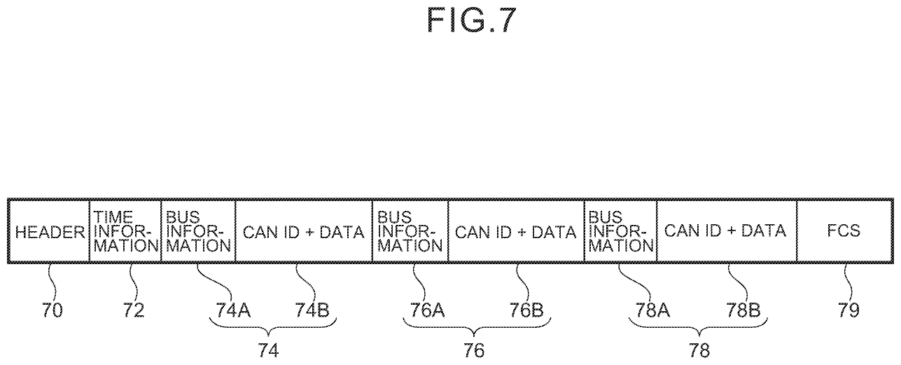

An example of the Ethernet frame structure in which the CAN data is packed is illustrated in FIG. 7. As illustrated in FIG. 7, the frame structure is structured to include a header 70, time information 72, a data portion 74, a data portion 76, a data portion 78, and an FCS (Frame Check Sequence) 79.

One header 70 and one time information 72 are set for one frame structure. The time information 72 is the counter timer value that was added as received time information at the received time adding section 46.

The data portion 74 is structured by receiving bus information 74A that was added at the receiving bus information adding section 48, and CAN data 74B that includes the CAN ID and a data field. Further, the data portion 76 is structured by receiving bus information 76A and CAN data 76B, and the data portion 78 is structured by receiving bus information 78A and CAN data 78B.

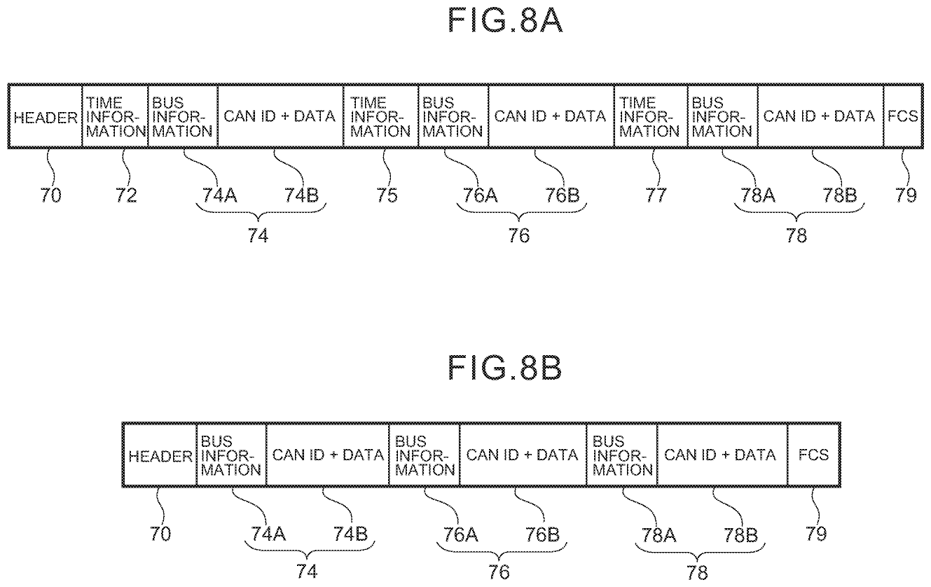

Note that the data packing section 50 is not limited to converting the CAN data into the frame structure illustrated in FIG. 7, and may convert the CAN data into another frame structure. For example, the data packing section 50 may convert the CAN data into the frame structures illustrated in FIG. 8A and FIG. 8B.

In the frame structure of a first modified example that is illustrated in FIG. 8A, time information 72, 75, 77 are added to the three data portions that are the data portion 74, the data portion 76, and the data portion 78, respectively. Concretely, the time information 72 is the received time information at which the CAN data 74B was received. The time information 75 is the received time information at which the CAN data 76B was received. The time information 77 is the received time information at which CAN data 78B was received. In the frame structure illustrated in FIG. 8A, because received time information is added to each of the CAN data, the correct received time information can be referred to at the time of verification.

On the other hand, in the frame structure of a second modified example that is illustrated in FIG. 8B, the time information 72 is not added to the frame structure of FIG. 7. For example, in cases of transmitting data at a uniform period, and in cases in which the period at which data is transmitted is short, the transmission time of the data can be used as the time information. Therefore, abnormalities in the received times can be detected even without adding the time information 72 to the frame structure.

Further, the data packing section 50 of the present embodiment packs the CAN data in cases in which the total data size of the CAN data that is stored by the storing processing section 44 is greater than or equal to a predetermined threshold value, or in cases in which a predetermined time period has elapsed from the transmitting of data for verification by the data for verification transmitting section 54 that is described later.

As illustrated in FIG. 2, the processing load acquiring section 52 acquires the processing load after the relay processing by the relay processing section 42. Various methods that are generally known can be employed in the measuring of the processing load. For example, the processing load acquiring section 52 may execute the same processing periodically, and the processing load may be measured by using a deriving method that is such that, the longer the time that is needed until the completion of processing, the greater the processing load.

The data for verification transmitting section 54 transmits, to a data storing section, the data for verification that has been packed by the data packing section 50. In the present embodiment, as an example, the DRAM 26 that is illustrated in FIG. 1 is set as the data storing section that is for verification. Therefore, the data for verification transmitting section 54 transmits the data for verification, which is stored in the SRAM 16, to the DRAM 26.

Here, the data for verification transmitting section 54 transmits the data for verification by a communication protocol of a wider band than the communication protocol that is used at the receiving section 40. In the present embodiment, as an example, at the receiving section 40, CAN protocol is used in order to receive the CAN data, whereas, at the data for verification transmitting section 54, the data for verification is transmitted to the DRAM 26 by virtual Ethernet communication. In virtual Ethernet communication, a physical Ethernet channel is not used, and the data for verification that has an Ethernet frame structure is transmitted via an internal bus of the relay device 10. Note that transmission is not limited to virtual Ethernet communication, and the data for verification may be transmitted to the DRAM 26 via the exterior of the relay device 10 by using a physical Ethernet channel.

Further, the data for verification transmitting section 54 of the present embodiment temporarily stops transmission to the data storing section in a case in which the processing load that is acquired by the processing load acquiring section 52 is greater than or equal to a predetermined threshold value. Namely, the transmitting of data by the data for verification transmitting section 54 is controlled so as to prioritize the relay processing by the relay processing section 42.

### Functional Structures of CPU Core 14

As illustrated in FIG. 3, the CPU core 14 of the relay device 10 is structured to include, as the functional structures thereof, a data for verification acquiring section 60, a data unpacking section 62, a verification processing section 64, a verification result recording section 66, and a verification result transmitting section 68. These respective functional structures are realized by the CPU core 14 reading-out and executing a program.

The data for verification acquiring section 60 accesses the DRAM 26 periodically, and acquires the data for verification that has an Ethernet frame structure.

By unpacking the acquired data for verification, the data unpacking section 62 can fetch individual CAN data from the frame structure.

The verification processing section 64 carries out verification of the individual CAN data. In the present embodiment, as an example, the verification processing section 64 verifies, for each of the CAN data 74B, 76B, 78B, whether the CAN ID thereof is a proper ID or is an improper ID. Further, the verification processing section 64 refers to the time of receiving that was added by the received time adding section 46 and the receiving bus information that was added by the receiving bus information adding section 48, and verifies whether these information are proper information or improper information. Moreover, the verification processing section 64 confirms numerical abnormalities of the data field and the like for each of the CAN data 74B, 76B, 78B.

The verification result recording section 66 records the results verified by the verification processing section 64, as a log in a predetermined storage such as the DRAM 26 or the like. In a case in which an abnormality has been discovered at the verification processing section 64, the verification result transmitting section 68 informs an external security center. Note that, instead of informing a security center, the verification result transmitting section 68 may carry out processing that changes the relay information expressing the routing map. In addition to informing the security center, the verification result transmitting section 68 may carry out processing that changes the relay information expressing the routing map. Further, the verification result transmitting section 68 may display the abnormality on a user interface such as a monitor or the like within the vehicle cabin. In this way, the CPU core 14 is equipped with a file system.

### Operation

Operation of the present embodiment is described next. First, an example of the relay processing by the CPU core 12 is described, and then an example of the verification processing by the CPU core 14 is described. Thereafter, the operation of the relay device 10 of the present embodiment is described.

### Example of Relay Processing

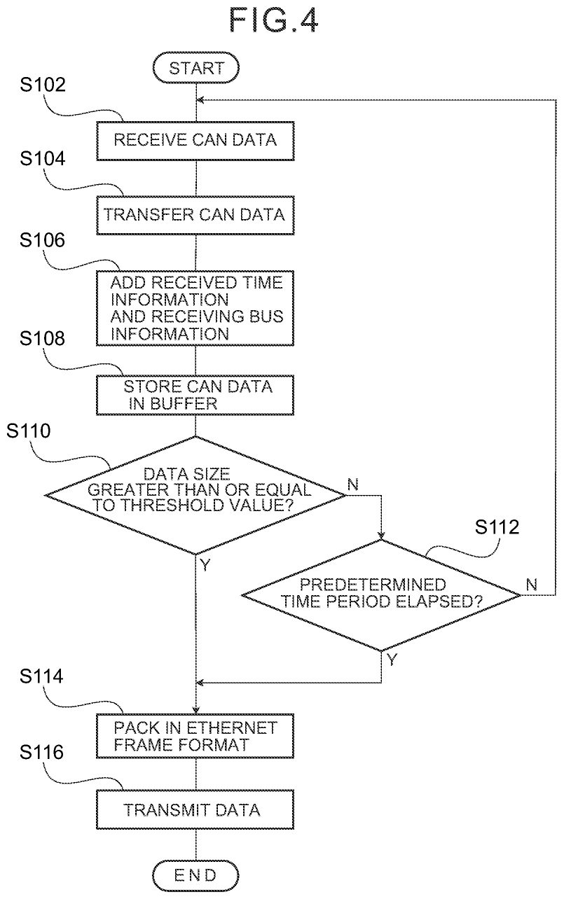

FIG. 4 is a flowchart illustrating an example of the flow of relay processing by the CPU core 12 of the relay device 10. This relay processing is executed by the CPU core 12 reading-out a program, and expanding and executing the program in the SRAM 16 or the like.

As illustrated in FIG. 4, in step 5102, the CPU core 12 receives CAN data. Concretely, by the function of the receiving section 40, the CPU core 12 receives CAN data from an external ECU or the like.

In step S104, the CPU core 12 transfers the received CAN data. Concretely, by the function of the relay processing section 42, the CPU core 12 refers to the relay information that is illustrated in FIG. 6, and transfers the CAN data to another CAN channel.

In step S106, the CPU core 12 adds received time information and receiving bus information to the received CAN data. For example, in a case in which the CAN data 74B is received, the CPU core 12 adds the time information 72 and the receiving bus information 74A to the CAN data 74B by the functions of the received time adding section 46 and the receiving bus information adding section 48.

In step S108, the CPU core 12 stores the received CAN data in a buffer. Concretely, by the function of the storing processing section 44, the CPU core 12 temporarily stores, in the SRAM 16, the CAN data that was received at the receiving section 40. At this time, the storing processing section 44 stores the CAN data in the SRAM 16 in a state in which the time information and the bus information have been added to the CAN data.

In step S110, the CPU core 12 determines whether or not the data size is greater than or equal to a predetermined threshold value. Concretely, the CPU core 12 acquires the total data size of the plural CAN data that are temporarily stored in the SRAM 16 that is a buffer, and, if the total data size is greater than or equal to a predetermined threshold value that is set in advance, the CPU core 12 moves on to the processing of step S114. The processing of step S114 is described later.

On the other hand, in step S110, if the total data size that is temporarily stored in the SRAM 16 is less than the predetermined threshold value that is set in advance, the CPU core 12 moves on to the processing of step S112.

In step S112, the CPU core 12 determines whether or not a predetermined time period has elapsed. Concretely, the CPU core 12 starts the counter timer at a predetermined time, and acquires the counter timer value at the point in time of step S112. Then, if the counter timer value is greater than or equal to a predetermined value, the CPU core 12 determines that the predetermined time period has elapsed, and moves on to the processing of step S114. On the other hand, in step S112, if the counter timer value is less than the predetermined value, the CPU core 12 determines that the predetermined time period has not elapsed, and returns to the processing of step S102. Note that, in the present embodiment, the counter timer value is reset after the data for verification is transmitted. Therefore, the measuring of time by the counter timer value is carried out from the time that the data for verification is transmitted to the time when the next data for verification is transmitted.

In step S114, the CPU core 12 collects plural CAN data, and packs the CAN data into a single Ethernet frame structure. Concretely, by the function of the data packing section 50, the CPU core 12 collects the plural CAN data that are stored in the SRAM 16, and packs (converts) them into a single data for verification.

In step S116, the CPU core 12 transmits the data for verification that was packed by the function of the data packing section 50. Concretely, by the function of the data for verification transmitting section 54, the CPU core 12 transmits the data for verification that is stored in the SRAM 16 to the DRAM 26 by virtual Ethernet communication or physical communication. Then, the CPU core 12 resets the counter timer value, and thereafter, ends the relay processing.

### Example of Verification Processing

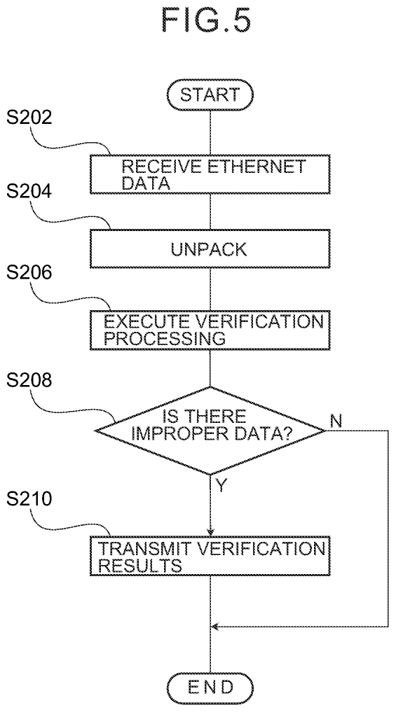

FIG. 5 is a flowchart illustrating an example of the flow of the verification processing by the CPU core 14 of the relay device 10. This verification processing is executed by the CPU core 14 reading-out a program, and expanding and executing the program in the SRAM 16 or the like.

As illustrated in FIG. 5, in step S202, the CPU core 14 receives Ethernet data. Concretely, by the function of the data for verification acquiring section 60, the CPU core 14 accesses the DRAM 26, and acquires the data for verification that has an Ethernet frame structure.

In step S204, the CPU core 14 unpacks the data for verification. Concretely, due to the CPU core 14 unpacking the data for verification by the function of the data unpacking section 62, the CPU core 14 can fetch the individual CAN data from the frame structure.

In step S206, the CPU core 14 carries out verification of the individual CAN data by the verification processing section 64. Detailed contents of the verification are as described above.

In step S208, as a result of the verification, the CPU core 14 determines whether or not there is improper data. Concretely, in a case in which abnormal data or improper data or the like are found at the time of the verification processing by the verification processing section 64, the CPU core 14 determines that there is improper data, and moves on to the processing of step S210. On the other hand, in a case in where there is no improper data in step S208, the CPU core 14 ends the verification processing.

In step S210, the CPU core 14 transmits the verification results. Concretely, by the function of the verification result transmitting section 68, the CPU core 14 notifies an external security center or the like regarding the improper data. Note that the CPU core 14 may change the destination to which the verification results are transmitted, in accordance with the contents of the improper data or the like. Then, the CPU core 14 ends the verification processing.

As described above, in the relay device 10 of the present embodiment, the CAN data that are received at the receiving section 40 are successively transferred by the relay processing section 42. Due thereto, delays in relaying can be suppressed more so than in a case in which data is transferred after verification.

Further, the received CAN data is temporarily stored by the storing processing section 44, and is converted into a single data for verification by the data packing section 50. Due thereto, the amount of data of the header can be reduced by an amount corresponding to the collecting of the plural CAN data, and the processing load can be reduced.

Moreover, in the relay device 10 of the present embodiment, the data for verification is transmitted to a data storage by the data for verification transmitting section 54. Due thereto, as compared with a case in which the CAN data are transmitted individually, the number of times of transmitting the data for verification can be reduced, and the processing load that is due to the transmitting of data can be reduced.

In particular, in the present embodiment, by transmitting the data for verification by using a communication protocol of a wider band than at the time of receiving, a large amount of data can be transmitted at one time.

Still further, in the relay device 10 of the present embodiment, in a case in which the total data size of the data that is stored by the storing processing section 44 is greater than or equal to a predetermined threshold value, the data packing section 50 packs the data. Due thereto, overflowing of the stored CAN data can be avoided. Further, even in a case in which the total data size is less than the predetermined threshold value, if a predetermined time period has elapsed, the data packing section 50 packs the data. Therefore, the interval until data is transmitted becoming long can be suppressed.

Further, in the relay device 10 of the present embodiment, by temporarily stopping transmission to the DRAM 26 in a case in which the processing load that is acquired by the processing load acquiring section 52 is greater than or equal to a predetermined threshold value, the transferring of data by the relay processing section 42 being delayed can be suppressed.

Moreover, in the present embodiment, due to receiving bus information being added to the CAN data by the receiving bus information adding section 48, the receiving bus information can be referenced at the time of verification by the CPU core 14, and can be used in the judging of improper data.

Still further, in the present embodiment, due to received time information being added to the CAN data by the received time adding section 46, the received time information can be referenced at the time of verification by the CPU core 14, and can be used in the judging of improper data.

In particular, in the present embodiment, by adding the counter timer value as the received time information, a function that acquires the time from the exterior or the like is not needed, as compared with a case of using an absolute time such as Greenwich Mean Time (GMT) or Coordinated Universal Time (UTC) or the like.

Although the relay device 10 relating to the present embodiment has been described above, the present disclosure can, of course, be implemented in various forms within a scope that does not depart from the gist thereof. For example, in the above-described embodiment, the data for verification, which is stored in the SRAM 16 by the data for verification transmitting section 54, is transmitted to the DRAM 26 that is a data storing section, but the present disclosure is not limited to this. Namely, the CPU core 14 that carries out the verification may access the SRAM 16 and acquire the data for verification. In this case, a shared memory that is shared by the CPU core 12 and the CPU core 14 may be provided separately, and the CPU core 12 may store the packed data for verification in this shared memory. Verification can be executed in the same way as in the present embodiment if the fact that the data for verification was packed is imparted at the CPU core 14, instead of the CPU core 12 not carrying out transmission of the data for verification.

Further, although the relay device 10 of the above-described embodiment is a so-called multicore structure that has the CPU core 12 and the CPU core 14, the present disclosure is not limited to this. For example, two CPUs that are physically independent may be used. In this case, one of the CPUs may carry out relay processing by functions that are similar to those of the CPU core 12, and the other CPU may carry out verification processing by functions that are similar to those of the CPU core 14.

Moreover, in the relay device 10 of the above-described embodiment, the CAN data is packed and transferred in a case in which the total data size of the CAN data is greater than or equal to a predetermined threshold value, or in a case in which a predetermined time period has elapsed from the transmitting of the data for verification by the data for verification transmitting section 54. However, the present disclosure is not limited to this. For example, the data for verification transmitting section 54 may transmit the data for verification at a predetermined period. In this case, if the data for verification is transmitted at an early period, the total data size of the CAN data does not become greater than or equal to the predetermined threshold value. Further, by transmitting the data for verification at a predetermined period, the received time can be discriminated even if received time information is not added, and improper data can be judged.

Still further, in the relay device 10 of the above-described embodiment, the relay processing section 42 refers to the relay information that is illustrated in FIG. 6, and transfers the CAN data to the relay bus that corresponds to the CAN ID of the received CAN data and the receiving bus information. However, the present disclosure is not limited to this, and, for example, the relay processing section 42 may decide upon the relay destination by referencing the data field of the CAN data.

Further, in the above-described embodiment, the object on which verification is carried out at the verification processing section 64 is made to be CAN data, but the present disclosure is not limited to this. For example, data that is received by a protocol such as LIN, UART, SPI, Ethernet, USB, PCIe or the like may be verified.

Moreover, any of various types of processors other than a CPU may execute the processings that the CPU core 12 and the CPU core 14 execute by reading in software (programs) in the above-described embodiment. Examples of processors in this case include PLDs (Programmable Logic Devices) whose circuit structure can be changed after production such as FPGAs (Field-Programmable Gate Arrays) and the like, or dedicated electrical circuits that are processors having circuit structures that are designed for the sole purpose of executing specific processings such as ASICs (Application Specific Integrated Circuits) and the like, or the like. Further, the relay processing and the verification processing may be executed by one of these various types of processors, or may be executed by combining two or more of the same type or different types of processors (e.g., plural FPGAs, or a combination of a CPU and an FPGA, or the like). Further, the hardware structures of these various types of processors are, more concretely, electrical circuits that combine circuit elements such as semiconductor elements and the like.

Moreover, in the above-described embodiment, the SRAM 16 and the DRAM 26 are made to be the memories that are non-transitory recording media, but the present disclosure is not limited to this. For example, a CD (Compact Disk), a DVD (Digital Versatile Disk), a USB (Universal Serial Bus) memory, or the like may be used as the non-transitory recording medium. In this case, various programs may be stored on these recording media.

What is claimed is:

1. A relay device for vehicle communication, comprising a processor, wherein the processor is configured to:
receive data for vehicle communication;
transfer the received data to a bus;
temporarily store the received data; and
collect a plurality of the stored data, and convert the plurality of data into single data for verification.

2. The relay device for vehicle communication of claim 1, wherein the processor transmits the data for verification to a data storing section that is for verification.

3. The relay device for vehicle communication of claim 2, wherein the processor transmits the data for verification by a communication protocol of a wider band than a communication protocol that is used at a time of receiving the data.

4. The relay device for vehicle communication of claim 2, wherein the processor packs the stored data, in a case in which a total data size of the stored data is greater than or equal to a predetermined threshold value, or in a case in which a predetermined time period has elapsed from transmitting of the data for verification.

5. The relay device for vehicle communication of claim 2, wherein the processor acquires a processing load after transfer of the data to the bus, and
in a case in which the acquired processing load is greater than or equal to a predetermined threshold value, the processor temporarily stops transmission to the data storing section.

6. The relay device for vehicle communication of claim 1, wherein the processor adds receiving bus information to the received data.

7. The relay device for vehicle communication of claim 1, wherein the processor adds received time information, which is based on a time of receiving, to the received data.

8. The relay device for vehicle communication of claim 7, wherein the received time information is a counter timer value that is reset at a time when the data is transmitted.

9. The relay device for vehicle communication of claim 2, wherein the processor transmits the data for verification at a predetermined period.

10. A relay method for vehicle communication, the method comprising, by a processor:
receiving data for vehicle communication;
transferring the received data to a bus, and temporarily storing the received data; and
collecting a plurality of the stored data, and converting the plurality of data into single data for verification.

11. A non-transitory storage medium that stores a program that is executable by a computer to perform processing, the processing comprising:
receiving data for vehicle communication;
transferring the received data to a bus, and temporarily storing the received data; and
collecting a plurality of the stored data, and converting the plurality of data into single data for verification.
